(19) United States
(12) Patent Application Publication
(10) Pub. No.: US 2026/0203567 A1
(43) Pub. Date: Jul. 16, 2026

(54) EVOLUTION OF TIME INTEGRAL NEURAL NETWORKS ON RECONFIGURABLE LOGIC FABRICS

(71) Applicant: ViVum Computing, South San Francisco, CA (US)

(72) Inventor: Derek WHITLEY, Bloomington, IN (US)

(73) Assignee: ViVum Computing, South San Francisco, CA (US)

(21) Appl. No.: 19/445,874

(22) Filed: Jan. 12, 2026

Related U.S. Application Data
(60) Provisional application No. 63/744,699, filed on Jan. 13, 2025.

(51) Int. Cl. G06N 3/063

(52) U.S. Cl. CPC G06N 3/063

(57) ABSTRACT

Techniques for evolving a population of time integral neural networks on a reconfigurable logic fabric are presented. The techniques include: programming time integral neural networks on a reconfigurable logic fabric; obtaining, by a processing system, outputs from a population of time integral neural networks, where the time integral neural networks include the population of time integral neural networks; selecting, according to a fitness function, a first subset of the population of time integral neural networks based on the outputs; reprogramming a second subset of the population of time integral neural networks, from which an evolved population of time integral neural networks is obtained, where the reprogramming includes applying at least one genetic operator to fixed-point binary representations of values of at least one parameter of the first subset of time integral neural networks; repeating the obtaining, the selecting, and the reprogramming; and identifying an output time integral neural network.

### RELATED APPLICATION

This application claims the benefit of US Provisional Ser. No. 63/744,699, entitled “Evolution of Time Integral Neural Networks on Reconfigurable Logic Fabrics,” and filed Jan. 13, 2025.

### FIELD

This disclosure relates generally to artificial intelligence, such as neural networks.

### BACKGROUND

Dynamic neural models (e.g., artificial neural networks whose state and/or synaptic activation are numerically integrated through time) include time integral neural networks, such as Continuous Time Recurrent Neural Networks (CTRNNs). CTRNNs are a type of recurrent neural network that can model the dynamics of neural activity using differential equations, which allows them to operate over continuous time. However, such mathematical descriptions are computationally expensive to model and simulate at scale due to the Von Neumann Bottleneck: the inevitable consequence of the separation of CPU and memory, which requires data to be constantly transferred back and forth. This limitation significantly hampers processing speed and efficiency. CTRNNs are particularly affected because each step of numerical integration (e.g., Euler or 4^{th} order Runge-Kutta) of the model requires substantial data exchange and processing. Thus, training and retraining time integral neural networks is a generally slow process, which makes sequentially tweaking and testing such neural networks at scale infeasible.

Reconfigurable logic fabrics include Field Programmable Gate Arrays (FPGAs) and Coarse-Grained Reconfigurable Arrays (CGRAs) can be designed with reduced latency and increased throughput by integrating memory and processors closely. Further, reconfigurable logic fabrics can provide highly parallel computational environments, suitable for tasks such as intensive numerical computations.

### SUMMARY

According to various embodiments, a method of evolving a population of time integral neural networks on at least one reconfigurable logic fabric is presented. The method includes: programming a plurality of time integral neural networks on at least one reconfigurable logic fabric, wherein the at least one reconfigurable logic fabric is communicatively coupled to a processing system; obtaining, by the processing system, outputs from a population of time integral neural networks, wherein the plurality of time integral neural networks comprises the population of time integral neural networks; selecting, by the processing system and according to a fitness function, a first subset of the population of time integral neural networks based on the outputs; reprogramming at least a second subset of the population of time integral neural networks, from which an evolved population of time integral neural networks is obtained, wherein the reprogramming comprises applying at least one genetic operator to fixed-point binary representations of values of at least one parameter of the first subset of time integral neural networks; repeating the obtaining, the selecting, and the reprogramming; and identifying an output time integral neural network based on the fitness function and based on the repeating.

Various optional features of the above method embodiments include the following. The method may include implementing the output time integral neural network on at least one hardware device for use in a deployed system. The processing system and the at least one reconfigurable logic fabric may be included in a deployed system during the repeating, the repeating may further include the identifying, from which a plurality of output time integral neural networks are obtained, and the deployed system may implement multiple of the plurality of output time integral neural networks in a hardware device during operation, such that the deployed system evolves in real time during operation. The deployed system may include at least one of: a drone, a robot, an autonomous vehicle, a predicative analytics system, or an adaptive control system. The applying the at least one genetic operator to the fixed-point binary representations may include applying the at least one genetic operator to at least a least significant bit of a decimal part of the fixed-point binary representations. The reprogramming may include partial reprogramming using at least one of Dynamic and Partial Reconfiguration (DPR), Direct Memory Access (DMA), Diversified Factory Key (DFK), or Advanced eXtensible Interface (AXI). The at least one reconfigurable logic fabric may include at least one Field Programmable Gate Array (FPGA). The processing system may be onboard the at least one reconfigurable logic fabric. The processing system may be on a hardware element separate from the at least one reconfigurable logic fabric. The at least one genetic operator may include at least one of: mutation or crossover. The at least one parameter may include one or more of: a neural network weight, a neural network bias, a time constant, a membrane conductance, a membrane resistance, a membrane decay/leak, or a relaxation. The fitness function may include at least one of: an absolute difference of differentials, a minimization of target values, a maximization of target values, or a sustainment of values in satisfiable range.

According to various embodiments, a system for evolving a population of time integral neural networks on at least one reconfigurable logic fabric is presented. The system include: at least one reconfigurable logic fabric on which a plurality of time integral neural networks are programmed; a processing system communicatively coupled to the at least one reconfigurable logic fabric, wherein the processing system is configured to perform actions comprising: obtaining outputs from a population of time integral neural networks, wherein the plurality of time integral neural networks comprises the population of time integral neural networks; selecting, according to a fitness function, a first subset of the population of time integral neural networks based on the outputs; reprogramming at least a second subset of the population of time integral neural networks, from which an evolved population of time integral neural networks is obtained, wherein the reprogramming comprises applying at least one genetic operator to fixed-point binary representations of values of at least one parameter of the first subset of time integral neural networks; repeating the obtaining, the selecting, and the reprogramming; and identifying an output time integral neural network based on the fitness function and based on the repeating.

Various optional features of the above system embodiments include the following. The system may include a deployed system comprising at least one hardware device on which the output time integral neural network is implemented. The system may include a deployed system, wherein the deployed system includes the processing system and the at least one reconfigurable logic fabric during the repeating, wherein the repeating further comprises the identifying, from which a plurality of output time integral neural networks are obtained, and wherein the deployed system implements multiple of the plurality of output time integral neural networks in a hardware device during operation, whereby the deployed system evolves in real time during operation. The deployed system may include at least one of: a drone, a robot, an autonomous vehicle, a predicative analytics system, or an adaptive control system. The applying the at least one genetic operator to the fixed-point binary representations may include applying the at least one genetic operator to at least a least significant bit of a decimal part of the fixed-point binary representations. The reprogramming may include partial reprogramming using at least one of Dynamic and Partial Reconfiguration (DPR), Direct Memory Access (DMA), Diversified Factory Key (DFK), or Advanced eXtensible Interface (AXI). The at least one reconfigurable logic fabric may include at least one Field Programmable Gate Array (FPGA). The processing system may be onboard the at least one reconfigurable logic fabric. The processing system may be on a hardware element separate from the at least one reconfigurable logic fabric. The at least one genetic operator may include at least one of: mutation or crossover. The at least one parameter may include one or more of: a neural network weight, a neural network bias, a time constant, a membrane conductance, a membrane resistance, a membrane decay/leak, or a relaxation. The fitness function may include at least one of: an absolute difference of differentials, a minimization of target values, a maximization of target values, or a sustainment of values in satisfiable range.

Combinations, (including multiple dependent combinations) of the above-described elements and those within the specification have been contemplated by the inventors and may be made, except where otherwise indicated or where contradictory.

### BRIEF DESCRIPTION OF THE DRAWINGS

Various features of the examples can be more fully appreciated, as the same become better understood with reference to the following detailed description of the examples when considered in connection with the accompanying figures, in which:

FIG. 1 is a schematic diagram illustrating a system for, and method of, evolving a population of time integral neural networks on a reconfigurable logic fabric, according to various embodiments;

FIG. 2 is a schematic diagram of an architecture suitable for offline evolving a population of time integral neural networks on a reconfigurable logic fabric, according to various embodiments;

FIG. 3 is a schematic diagram of an architecture suitable for online evolving a population of time integral neural networks on a reconfigurable logic fabric, according to various embodiments;

FIG. 4 is a flow chart of a method for offline evolving a population of time integral neural networks on a reconfigurable logic fabric, according to various embodiments; and

FIG. 5 is a flow chart of a method for online evolving a population of time integral neural networks on a reconfigurable logic fabric, according to various embodiments.

### DESCRIPTION OF THE EXAMPLES

Reference will now be made in detail to example implementations, illustrated in the accompanying drawings. Wherever convenient, the same reference numbers will be used throughout the drawings to refer to the same or like parts. In the following description, reference is made to the accompanying drawings that form a part thereof, and in which is shown by way of illustration specific exemplary examples in which the invention may be practiced. These examples are described in sufficient detail to enable those skilled in the art to practice the invention and it is to be understood that other examples may be utilized and that changes may be made without departing from the scope of the invention. The following description is, therefore, merely exemplary.

Some embodiments provide a neuroevolution framework that dramatically enhances the speed and efficiency of artificial intelligence evolution, training, and simulation. Some embodiments utilize genetic algorithms in conjunction with reconfigurable logic fabrics, such as Field Programmable Gate Arrays (FPGAs) or Coarse-Grained Reconfigurable Arrays (CGRAs), specifically targeting dynamic and flexible modification of the binary representations of hardware parameters for the generation of broad classes of dynamical neuroethologies.

By employing genetic algorithms, some embodiments iteratively modify the partial bitstreams—essentially the genetic instructions—that define the configuration of reconfigurable logic fabric hardware devices. Some embodiments exploit the confinement of reconfigurable logic fabrics to fixed-point arithmetic, as opposed to floating-point arithmetic as is common in modern computing environments. For example, because FPGAs may utilize fixed-point arithmetic, e.g., Q format, every parameter may be represented by a genome of 1's and 0's. Therefore sexual crossover or mutation of a given allele within the genome can provide an approach via natural selection toward a stable dynamical ethology.

Some embodiments use the adaptive nature of genetic algorithms to fine-tune neuron parameters in response to ongoing performance feedback, optimizing the network's computational efficiency and accuracy in real-time. According to some embodiments, because the individual bit-flips performed during the evolutionary process do not necessitate a complete reprogramming of the device configuration, some embodiments provide an extremely lightweight and high frequency partial reconfiguration of the genome of the neural networks.

Some embodiments utilize reconfigurable logic fabrics to alleviate the impact of the Von Neumann bottleneck on time integral neural networks. Some embodiments exploit the integrated memory and processors of reconfigurable logic fabrics to efficiently perform the intensive numerical integration utilized by time integral neural networks. This allows some embodiments to efficiently train and implement time integral neural networks, representing an improvement over prior art techniques for selecting and implementing time integral neural networks.

Some embodiments utilize reconfigurable logic fabric reprogramming to train and retrain a population of time integral neural networks in parallel. This not only substantially speeds up the training process of an individual neural network, but also allows for retraining and evaluating a large population of neural networks in parallel. Thus, some embodiments utilize the parallelism of reconfigurable logic fabrics to perform simultaneous computations on multiple time integral neural networks at multiple time-scales, allowing for massive parallelism during training, resulting in significant reductions in the time required for evolution and simulation as compared to traditional serial computing approaches.

Some embodiments facilitate evolving a population of time integral neural networks in order to quickly obtain and identify an output neural network that has desired properties. To facilitate such evolution, some embodiments apply one or more genetic operators to fixed-point binary representations of values of one or more parameters of multiple time integral neural networks in parallel. The application of genetic operators to fixed-point binary representations as used in reconfigurable logic fabrics facilitates hardware accelerated time integral neural network evolution. Thus, the usage of reconfigurable logic fabric, evolving a population, and genetic operators applied to fixed-point binary representations overcomes the disadvantageously slow prior art process of evolving time integral neural networks to identify and output a time integral neural network with desired fitness properties.

These and other features and advantages are shown and described herein in reference to the accompanying figures.

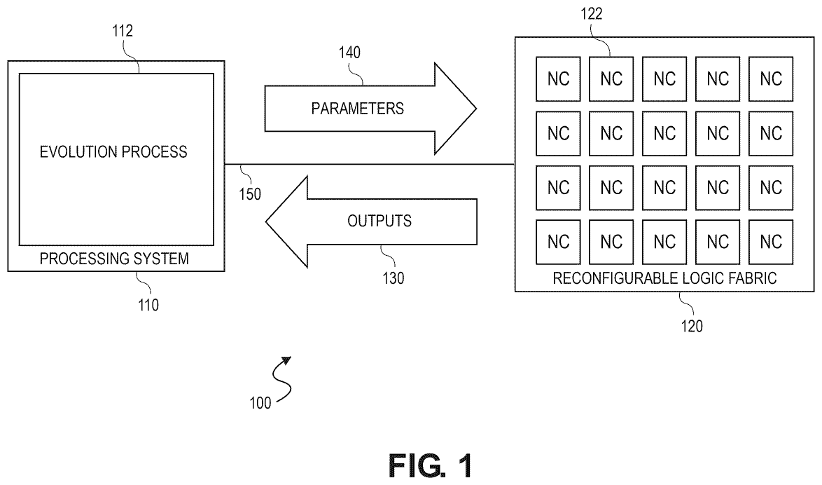

FIG. 1 is a schematic diagram illustrating a system 100 for, and method of, evolving a population of time integral neural networks on a reconfigurable logic fabric, according to various embodiments. As shown in FIG. 1, the system includes a reconfigurable logic fabric 120 communicatively coupled to a processing system 110 via a communication channel 150.

The reconfigurable logic fabric 120 may include any of a variety of hardware according to various embodiments. By way of non-limiting example, the reconfigurable logic fabric 120 may be implemented using a FPGA, a CGRA, or a different reprogrammable hardware integrated circuit. Note that although FIG. 1 illustrates a single reconfigurable logic fabric 120, embodiments are not so limited. Various embodiments may implement the neural cores (e.g., 122) on one or a plurality of reconfigurable logic fabrics (e.g., 120).

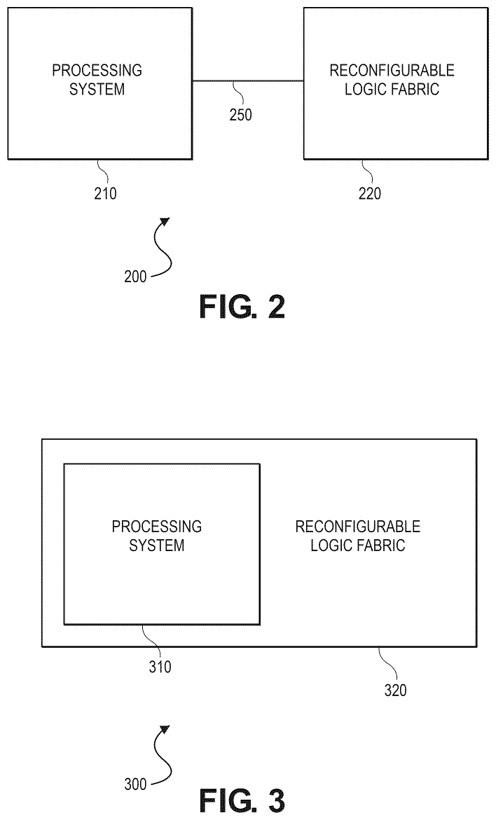

The processing system 110 may include any of a variety of hardware according to various embodiments. According to some embodiments, e.g., as shown and described herein in reference to FIG. 2, the processing system 110 may be implemented using a central processing unit, which may include one or more processing cores. According to some embodiments, e.g., as shown and described herein in reference to FIG. 3, the processing system 110 may be implemented using a reconfigurable logic fabric, e.g., on the reconfigurable logic fabric 120.

The communication channel 150 may be implemented using any of a variety of hardware. According to some embodiments, e.g., as shown and described herein in reference to FIG. 2, the communication channel may be implemented as an electronic bus external to the processing system 110 and the reconfigurable logic fabric. According to some embodiments, e.g., as shown and described herein in reference to FIG. 3, the communication channel may be implemented as an internal electronic bus of the reconfigurable logic fabric 120. Essentially any hardware communication channel that facilitates digital communication between the processing system 110 and the reconfigurable logic fabric 120 may be used.

The reconfigurable logic fabric 120 hosts a plurality of hardware neural cores (e.g. 122). In general, the reconfigurable logic fabric 120 may host any number of hardware neural cores, e.g., from ten to several tens of thousands. In general, each neural core (e.g., 122) may be programmed to implement any of a variety of neural networks. Each neural network implemented in a respective neural core (e.g., 122) may include a plurality of layers, and each layer may include a plurality of synthetic neurons implemented in silico. In general, each neural network may include several up to several thousand synthetic neurons.

According to various embodiments, each neural core (e.g., 122) may implement any of a variety of dynamic neural networks (e.g., instance-wise dynamic models, spatial-wise dynamic networks, temporal-wise dynamic models, sample-wise dynamic networks, and/or early-exit networks). According to some embodiments, each neural core may implement a time integral neural network, which may include a plurality of time integral neurons. According to some embodiments, each neural core (e.g., 122) may implement a Recurrent Neural Network (RNN), e.g., a CTRNN. For purposes of illustration rather than limitation, a detailed description of example CTRNNs follows.

A CTRNN may be trained to make predictions (e.g., inferences such as classifications and/or regressions) for a system that changes throughout time. A CTRNN may be trained using updated observations (e.g., measurements) of the system, which may occur irregularly. For example, a CTRNN may include a hidden state that develops continuously in time between times at which the CTRNN receives as inputs observations (e.g., measurements) of the system. Each input observation, which may be obtained at regular or irregular temporal intervals, may cause a (possibly discontinuous) update of the hidden state. Thus, the hidden state of a CTRNN may change over time, continuously between inputs, and potentially discontinuously at each input observation. Moreover, a CTRNN may accept a new input, which may include a time value and/or an observation, and output a corresponding prediction for the system that it models. Note that the time value may be an actual time value or a declared time value, and the observation may be an actual observation (e.g., a measurement) or a declared (e.g., fiat) observation.

A CTRNN may include an architecture component that performs the discontinuous updates to the hidden state when it receives an observation input, and also an architecture component that develops the hidden state as time passes between inputs. The former architecture component may be implemented using one or more RNN layers (e.g., a full RNN). The latter architecture component may be implemented using one or more neural differential equations or neural flows. Further, the latter architecture may implement numerical integration techniques, e.g., to solve one or more differential equations. As shown and described herein, implementing a CTRNN (or similar neural networks) in a neural core (e.g., 122) of a reconfigurable logic fabric 120, such as an FPGA, efficiently facilitates such numerical techniques, e.g., by avoiding the Von Neumann bottleneck of typical computer architectures. Further, implementing a CTRNN (and similar neural networks) in a neural core (e.g., 122) of a reconfigurable logic fabric 120, such as an FPGA, facilitates performing a full numerical integration operation in a single clock cycle, and the reconfigurable logic fabric 120 may perform thousands of such integrations in parallel.

Whether CTRNNs or other neural networks, the neural networks may be programmed into the reconfigurable logic fabric 120 using known transfer protocols such as, by way of non-limiting examples: Dynamic and Partial Reconfiguration (DPR), Direct Memory Access (DMA), or Advanced eXtensible Interface (AXI). According to some embodiments, states and parameters for the neural networks may be represented in fixed-point arithmetic format (e.g., Q5.11, Q4.12, or others) and programmed into the reconfigurable logic fabric 120.

Each neural network of a respective neural core (e.g., 122) is programmed with one or more associated parameters. For each neural network, the respective parameters may include one or more of: a neural network weight (typically many such weights), a neural network bias (typically many such biases), a time constant, a membrane conductance, a membrane resistance, a membrane decay/leak, and/or a relaxation, by way of non-limiting examples. The time constant, for example, is a parameter associated with each individual neuron in a time integral neural network, and characterizes how quickly its activation level changes in response to input signals. In general, each parameter may be represented as, and programmed into a respective neural core (e.g., 122), in fixed-point arithmetic format (e.g., Q5.11).

The processing system 110 implements an evolution process 112, which facilitates a training process for a population of neural networks, e.g., all, or a subset, of the neural networks implemented in the neural cores (e.g., 122) of the reconfigurable logic fabric 120. To facilitate the training process, the evolution process 112 may include an algorithm that, generally described, includes obtaining outputs 130 from each neural network implemented in the reconfigurable logic fabric 120, evaluating respective fitnesses of the neural networks based on the outputs, and providing mutated parameters 140 back to the reconfigurable logic fabric 120 for implementing in at least some of the neural networks based on the fitness evaluation. In general, the training may mutate one or more respective parameters of one or more of the neural networks. The evolution system 112 may mutate the parameters by applying one or more genetic operators to fixed-point binary representations of values for the parameters. The training process may be performed repeatedly, such that the embodiments evolve the population of neural networks.

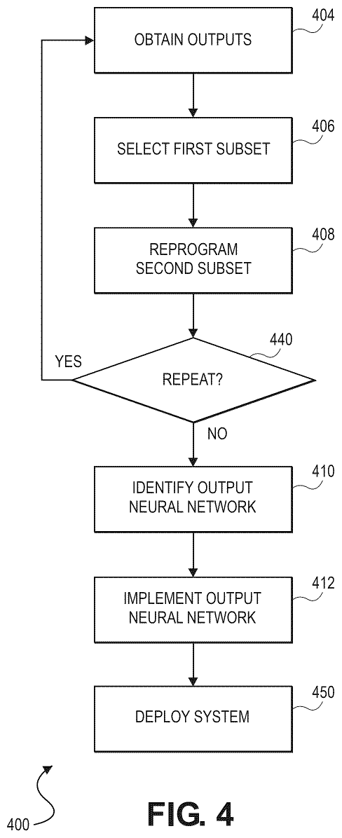

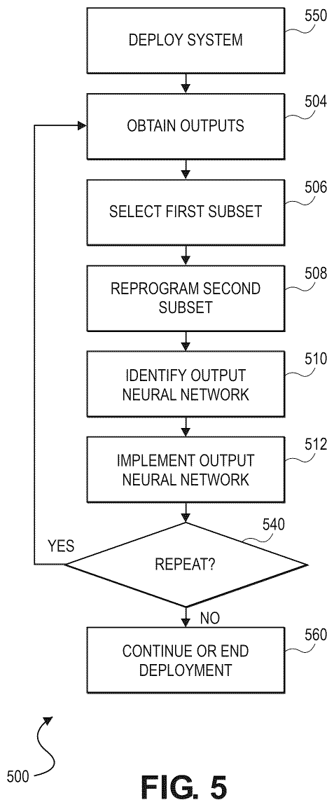

The training process may be performed offline or online. For example, according to some embodiments, the training process may be performed offline so as to evolve and identify a neural network that may be implemented in a system for later deployment. Details of an example offline evolution process are shown and described herein in reference to FIG. 4. As another example, according to some embodiments, the training process may be performed online so as to evolve an implemented neural network as it operates in a deployed system. Details of an example online evolution process are shown and described herein in reference to FIG. 5.

FIG. 2 is a schematic diagram of an architecture 200 suitable for offline evolving a population of time integral neural networks on a reconfigurable logic fabric, according to various embodiments. The architecture 200 includes a processing system 210 implemented in hardware separate from, and connected by a hardware communication channel 250 to, the reconfigurable logic fabric 220. The processing system 210 may include a CPU, which itself may include multiple processing cores. The processing system 210 may include a server computer. For example, according to some embodiments, the reconfigurable logic fabric is implemented in the cloud. According to some embodiments, the processing system 210 includes a server computer, the reconfigurable logic fabric 220 includes one or multiple FPGAs, and the communication channel 250 includes one or multiple PCIe slots into which the FPGA(s) is/are inserted. Note that for various embodiments, the reconfigurable logic fabric 220 may be replaced by standard electronic memory, e.g., Random Access Memory (RAM). Replacement of the reconfigurable logic fabric 220 by standard electronic memory may occur for embodiment that utilize the cloud, for example.

Note that although the architecture 200 is suitable for an offline evolution process, neither it nor the offline evolution process are so limited. According to various embodiments, the architecture 200 may be used for an online evolution process, and an offline evolution process may be implemented in hardware different from that of the system 200 shown and described in reference to FIG. 2.

FIG. 3 is a schematic diagram of an architecture 300 suitable for online evolving a population of time integral neural networks on a reconfigurable logic fabric, according to various embodiments. The architecture 300 includes a processing system 310 integrated with the reconfigurable logic fabric 320. The processing system 310 may include one or multiple processing cores. The communication channel 350 may also be integrated with the reconfigurable logic fabric 320. According to some embodiments, the processing system 310 includes a MultiProcessor System on Chip (MPSoC) that includes one or more microprocessors integrated with the reconfigurable logic fabric 320.

Note that although the architecture 300 is suitable for an online evolution process, neither it nor the online evolution process are so limited. According to various embodiments, the architecture 300 may be used for an offline evolution process, and an online evolution process may be implemented in hardware different from that of the system 300 shown and described in reference to FIG. 3.

FIG. 4 is a flow chart of a method 400 for offline evolving a population of time integral neural networks on a reconfigurable logic fabric, according to various embodiments. The method 400 may be implemented using a system such as the system 100 as shown and described herein in reference to FIG. 1, the system 200 as shown and described herein in reference to FIG. 2, or the system 300 as shown and described herein in reference to FIG. 3. Note that the system 200 is particularly amendable to implementing the method 400, because the architecture facilitates multiple reconfigurable logic fabrics connected to, and evolved using, a processing system.

At the start of the method 400, a plurality of neural networks, e.g., time integral neural networks such as CTRNNs, may be programmed in the reconfigurable logic fabric. According to some embodiments, values for one or more parameters may be randomly selected and programmed in the neural networks. The plurality of neural networks may include a distribution of parameter values, and with high probability (e.g., >99%) no two neural networks may have identical parameter values.

At 404, the method 400 includes obtaining, by the processing system, outputs from a population of neural networks. The population of time integral neural networks may include all, or a subset, of the plurality of time integral neural networks programmed in the reconfigurable logic fabric. The outputs, which include respective outputs from each of the neural networks in the population, may be in response to an input to each of the neural networks. The input may include a time value and/or an observation, and either or both of the time value and observation may be declared or measured. The input may represent any of a variety of physical and/or internal parameters, e.g., parameters associated with a drone (e.g., yaw, pitch, roll, three-axis acceleration, position, etc.), a robot (e.g., end effector position and status, robot position and status, etc.), an autonomous vehicle (e.g., position, velocity, acceleration, etc.), a predicative analytics system (e.g., current or historical data, time values, etc.), or an adaptive control system (e.g., process parameters, failure or maintenance predictions, robot feedback, etc.).

At 406, the method 400 includes selecting, by the processing system and according to a fitness function, a first subset of the population of time integral neural networks based on the outputs. In general, the first subset may include those time integral neural networks that are deemed to have superior fitness according to the fitness function. The particular fitness function may include any of a variety of fitness functions, depending on the particular embodiment and use case. The fitness function may be single-objective or multi-objective. By way of non-limiting examples, the fitness function may include any of: an absolute difference of differentials, a minimization of target values, a maximization of target values, or a sustainment of values in satisfiable range. The fitness function may include a summed minimization or maximization of any of a plurality of fitness functions, e.g., any of the aforementioned examples. According to some embodiments, the first subset may be selected according to whether the fitness function applied to a particular neural network exceeds (or is below) a threshold value. The threshold value may be fixed or dynamic.

At 408, the method 400 includes reprogramming at least a second subset of the population of time integral neural networks, from which an evolved population of time integral neural networks is obtained. The reprogramming may include applying one or more genetic operators to fixed-point binary representations of values of at least one parameter of the first subset of time integral neural networks.

According to various embodiments and use cases, the second subset may be the same as the first subset, may be included in the first subset, may include the first subset, or may partially overlap the first subset. For example, according to some embodiments, the first subset of neural networks are reprogrammed by applying genetic operator(s), and the neural networks outside of the first subset may be randomly reset and/or reprogrammed, e.g., using the genetic operator(s).

The reprogramming may include partial reprogramming, e.g., where only some values in each of the neural networks in the second subset are changed. The reprogramming may use any of a variety of transfer protocols, including, by way of non-limiting examples: Dynamic and Partial Reconfiguration (DPR), Direct Memory Access (DMA), Advanced eXtensible Interface (AXI). According to some embodiments, the reprogramming may occur while the neural networks in the second subset are operational.

The genetic operator(s) used for 408 may include one or both of mutation or crossover. Mutation may include randomly changing one or more bits. Crossover may include replacing one or more bits with bits from another neural network. The genetic operators may be random or pseudorandom, and may, or may not, use elitism according to various embodiments. Elitism may include leaving a portion of the population, the best (e.g., according to the fitness function(s)) neural networks, unchanged. The rate of mutation may be set as a parameter, e.g., one in N, where N is an integer that may range from several to several thousand.

In general, because the neural networks are implemented in a reconfigurable logic fabric, they may be completely characterized by associated respective bit streams, which are used to program and reprogram them. The bit streams may be in the format of fixed-point binary representations. According to some embodiments, the fixed-point binary representations may be Q5.11, where, for each value, five bits are allocated to an integer part of the value and eleven bits are allocated to a decimal part of the value. According to various embodiments, the genetic operator(s) may be applies to a least significant bit of a decimal part of the fixed-point binary representations. According to various embodiments, the genetic operator(s) may be applied to one or more bits of increasing significance in addition to the least significant bit. Note that the use of fixed-point binary representation according to some embodiments is particularly advantageous (e.g., over floating point representation) because it is natively understood by various reconfigurable logic fabrics (e.g., FPGA) and amenable to changing a least-significant bit (and possibly one or more bits in addition to the least significant bit).

According to various embodiments, the values of any of a variety of parameters may be subject to reprogramming per 408. By way of non-limiting example, such parameter(s) may include one or more of: a neural network weight (e.g., many such weights), a neural network bias (e.g., many such biases), a time constant, a membrane conductance, a membrane resistance, a membrane decay/leak, and/or a relaxation, by way of non-limiting examples.

At 440, the method 400 includes determining whether to repeat the obtaining of 404, the selecting of 406, and the reprogramming of 408. According to some embodiments, the decision may be based on whether at least one neural network has desired properties based on the fitness function. According to some embodiments, the decision may be based on whether a predetermined number of iterations of the obtaining of 404, the selecting of 406, and the reprogramming of 408 have occurred. According to some embodiments, the decision may be based on a combination (e.g., conjunction or disjunction) of the aforementioned bases. If the determination is that the obtaining of 404, the selecting of 406, and the reprogramming of 408 should be repeated, then control reverts to 404. Otherwise, control passes to 410.

At 410, the method 400 includes identifying an output time integral neural network based on the fitness function and based on the repeating. By way of non-limiting example, the output neural network may be identified according to the value of the fitness function as applied to its outputs. The identification may include, or consist of, identifying the values for the parameters of the neural network. The identification may include outputting identification information (e.g., parameter values and/or neural network identification, such as in the form of a serial number or hash value) from the system. The identification may be in the form of human-readable or machine-readable data.

At 412, the method 400 includes implementing the output neural network on at least one hardware device. The actions of 412 may include programming the output neural network on a hardware logic device, e.g., a microprocessor, microcontroller, or reconfigurable logic fabric included in, or separate from, the system the implements the prior actions of the method 412. The actions of 412 may include setting values of parameters in a preprogrammed neural network to those of the output neural network.

At 450, the method 400 includes deploying the hardware device in which the output neural network is implemented. The deployed system may include, by way of non-limiting examples: a drone, a robot, an autonomous vehicle, a predicative analytics system, or an adaptive control system.

FIG. 5 is a flow chart of a method 500 for online evolving a population of time integral neural networks on a reconfigurable logic fabric, according to various embodiments. The method 500 may be implemented using a system such as the system 100 as shown and described herein in reference to FIG. 1, the system 200 as shown and described herein in reference to FIG. 2, or the system 300 as shown and described herein in reference to FIG. 3. Note that the system 300 is particularly amendable to implementing the method 500, because the architecture facilitates very fast (e.g., real time) evolution of the population of time integral neural networks.

Certain actions of the method 500 are similar to certain actions of the method 400 as previously shown and described herein. In general, action 404 corresponds with 504, 406 corresponds with 506, 408 corresponds with 508, 410 corresponds with 510, 412 corresponds with 512, 450 corresponds with 550, and 460 corresponds with 560. Nevertheless, the corresponding actions may or may not be identical as described, depending on particular implementations and particular embodiments. Examples of similarities and differences are disclosed presently.

At 550, the method 500 includes deploying a system that evolves a population of time integral neural networks on a reconfigurable logic fabric. The system may include, by way of non-limiting examples: a drone, a robot, an autonomous vehicle, a predicative analytics system, or an adaptive control system. The system may be deployed in an operational environment typical for the particular system.

At 504, the method 500 includes obtaining, by the processing system, outputs from a population of neural networks. The population of time integral neural networks may include all, or a subset, of the plurality of time integral neural networks programmed in the reconfigurable logic fabric. The outputs, which include respective outputs from each of the neural networks in the population, may be in response to an input to each of the neural networks. The input may include a time value and/or an measured observation. The input may represent any of a variety of physical and/or internal parameters of the deployed system, e.g., parameters associated with a deployed drone (e.g., yaw, pitch, roll, three-axis acceleration, position, etc.), a deployed robot (e.g., end effector position and status, robot position and status, etc.), a deployed autonomous vehicle (e.g., position, velocity, acceleration, etc.), a deployed predicative analytics system (e.g., current or historical data, time values, etc.), or a deployed adaptive control system (e.g., process parameters, failure or maintenance predictions, robot feedback, etc.).

At 506, the method 500 includes selecting, by the processing system and according to a fitness function, a first subset of the population of time integral neural networks based on the outputs. In general, the actions of 506 maybe as shown and described herein in reference to 406 of the method 400.

At 508, the method 500 includes reprogramming at least a second subset of the population of time integral neural networks, from which an evolved population of time integral neural networks is obtained. In general, the actions of 508 may be as shown and described herein in reference to 408 of the method 400. Note that DPR, DFK, and DMA transfer protocols are particularly amenable to real time reprogramming in deployed systems. Real time reprogramming not only speeds up the evolution and training times, but also enhances the ability to dynamically adapt to new data or operational conditions without the need for complete retraining. Further, this approach provides substantial improvements in the efficiency and adaptability of deployed systems, particularly in fields requiring rapid response to evolving data landscapes.

At 510, the method 500 includes identifying an output neural network based on the fitness function and based on the repeating. In general, the actions of 510 may be as shown and described herein in reference to 410 of the method 400. In general, the identification may be in the form of machine-readable data.

At 512, the method 500 includes implementing the output neural network on at least one hardware device of the deployed system. The actions of 512 may include programming the output neural network, or reprogramming an existing neural network as the output neural network, on a hardware logic device, e.g., a microprocessor, microcontroller, or reconfigurable logic fabric, included in the deployed system. The actions of 512 may include setting values of parameters in a neural network that is operational in the deployed system to those of the output neural network, e.g., while the neural network is operational.

At 450, the method 500 includes determining whether to repeat the obtaining of 504, the selecting of 506, the reprogramming of 508, the identifying of 510, and the implementing of 512. According to some embodiments, the decision may be based on whether at least one neural network has desired properties based on the fitness function. According to some embodiments, the decision may be based on whether a predetermined number of iterations of the obtaining of 504, the selecting of 506, and the reprogramming of 508 have occurred. According to some embodiments, the decision may be based on whether they system remains deployed and/or operational. According to some embodiments, the decision may be based on a decision as to whether the deployed system should continue to evolve, which itself may be based on, e.g., a length of deployment and/or any of the aforementioned bases. According to some embodiments, the decision may be based on a combination (e.g., conjunction or disjunction) of any of the aforementioned bases. If the determination is that the obtaining of 504, the selecting of 506, the reprogramming of 508, the identifying of 510, and the implementing of 512 should be repeated, then control reverts to 504. Otherwise, control passes to 560.

Note that if the obtaining of 504, the selecting of 506, the reprogramming of 508, the identifying of 510, and the implementing of 512 are repeated, then the deployed system evolves during deployment, e.g., while operational. For example, during deployment, a plurality of output neural networks may be identified, e.g., in sequence as the loop of the method 500 repeats. For each repetition, a new, or updated output neural network may be identified and implemented in a hardware device of the deployed system during operation. Accordingly, the repetition allows the deployed system to evolve in real time during operation.

At 560, the method 500 may end, e.g., with the deployment of the system either continuing or ending. For example, in some embodiments, even if the actions of the method 500 end, the deployed system may continue operation. According to some embodiments, operation of the deployed system may end after the decision of 540 is to not repeat the prior actions.

Various modifications, alternative implementations, and combinations of the explicitly disclosed embodiments are possible. For example, hyperparameters may be genetically modified, such as by including the evolution process (e.g., a genetic operator thereof) directly in the reconfigurable logic fabric

Certain examples can be performed using a computer program or set of programs. The computer programs can exist in a variety of forms both active and inactive. For example, the computer programs can exist as software program(s) comprised of program instructions in source code, object code, executable code or other formats; firmware program(s), or hardware description language (HDL) files. Any of the above can be embodied on a transitory or non-transitory computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), flash memory, and magnetic or optical disks or tapes.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented using computer readable program instructions that are executed by an electronic processor.

These computer readable program instructions may be provided to a processor of a general-purpose computer, special purpose computer, or other programmable data processing apparatus to produce a machine, such that the instructions, which execute via the electronic processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In embodiments, the computer readable program instructions may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on a user's computer, partly on the user's computer, as a stand-alone software package, partly on the user's computer and partly on a remote computer or entirely on the remote computer or server.

As used herein, the terms “A or B” and “A and/or B” are intended to encompass A, B, or {A and B}. Further, the terms “A, B, or C” and “A, B, and/or C” are intended to encompass single items, pairs of items, or all items, that is, all of: A, B, C, {A and B}, {A and C}, {B and C}, and {A and B and C}. The term “or” as used herein means “and/or.”

As used herein, language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112(f). However, for any claims containing elements designated in any other manner, it is intended that such elements are not to be interpreted under 35 U.S.C. § 112(f).

While the invention has been described with reference to the exemplary examples thereof, those skilled in the art will be able to make various modifications to the described examples without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. A method of evolving a population of time integral neural networks on at least one reconfigurable logic fabric, the method comprising:
programming a plurality of time integral neural networks on at least one reconfigurable logic fabric, wherein the at least one reconfigurable logic fabric is communicatively coupled to a processing system;
obtaining, by the processing system, outputs from a population of time integral neural networks, wherein the plurality of time integral neural networks comprises the population of time integral neural networks;
selecting, by the processing system and according to a fitness function, a first subset of the population of time integral neural networks based on the outputs;
reprogramming at least a second subset of the population of time integral neural networks, from which an evolved population of time integral neural networks is obtained, wherein the reprogramming comprises applying at least one genetic operator to fixed-point binary representations of values of at least one parameter of the first subset of time integral neural networks;
repeating the obtaining, the selecting, and the reprogramming; and
identifying an output time integral neural network based on the fitness function and based on the repeating.

2. The method of claim 1, further comprising implementing the output time integral neural network on at least one hardware device for use in a deployed system.

3. The method of claim 1,
wherein the processing system and the at least one reconfigurable logic fabric are included in a deployed system during the repeating,
wherein the repeating further comprises the identifying, from which a plurality of output time integral neural networks are obtained, and
wherein the deployed system implements multiple of the plurality of output time integral neural networks in a hardware device during operation,
whereby the deployed system evolves in real time during operation.

4. The method of claim 3, wherein the deployed system comprises at least one of: a drone, a robot, an autonomous vehicle, a predicative analytics system, or an adaptive control system.

5. The method of claim 1, wherein the applying the at least one genetic operator to the fixed-point binary representations comprises applying the at least one genetic operator to at least a least significant bit of a decimal part of the fixed-point binary representations.

6. The method of claim 1, wherein the reprogramming comprises partial reprogramming using at least one of Dynamic and Partial Reconfiguration (DPR), Direct Memory Access (DMA), Diversified Factory Key (DFK), or Advanced eXtensible Interface (AXI).

7. The method of claim 1, wherein the at least one reconfigurable logic fabric comprises at least one Field Programmable Gate Array (FPGA).

8. The method of claim 1, wherein the processing system is onboard the at least one reconfigurable logic fabric.

9. The method of claim 1, wherein the processing system is on a hardware element separate from the at least one reconfigurable logic fabric.

10. The method of claim 1, wherein the at least one genetic operator comprises at least one of: mutation or crossover.

11. The method of claim 1, wherein the at least one parameter comprises one or more of: a neural network weight, a neural network bias, a time constant, a membrane conductance, a membrane resistance, a membrane decay/leak, or a relaxation.

12. The method of claim 1, wherein the fitness function comprises at least one of: an absolute difference of differentials, a minimization of target values, a maximization of target values, or a sustainment of values in satisfiable range.

13. A system for evolving a population of time integral neural networks on at least one reconfigurable logic fabric, the system comprising:
at least one reconfigurable logic fabric on which a plurality of time integral neural networks are programmed;
a processing system communicatively coupled to the at least one reconfigurable logic fabric, wherein the processing system is configured to perform operations comprising:
obtaining outputs from a population of time integral neural networks, wherein the plurality of time integral neural networks comprises the population of time integral neural networks;
selecting, according to a fitness function, a first subset of the population of time integral neural networks based on the outputs;
reprogramming at least a second subset of the population of time integral neural networks, from which an evolved population of time integral neural networks is obtained, wherein the reprogramming comprises applying at least one genetic operator to fixed-point binary representations of values of at least one parameter of the first subset of time integral neural networks;
repeating the obtaining, the selecting, and the reprogramming; and
identifying an output time integral neural network based on the fitness function and based on the repeating.

14. The system of claim 13, further comprising a deployed system comprising at least one hardware device on which the output time integral neural network is implemented.

15. The system of claim 13, further comprising a deployed system, wherein the deployed system includes the processing system and the at least one reconfigurable logic fabric during the repeating,
wherein the repeating further comprises the identifying, from which a plurality of output time integral neural networks are obtained, and
wherein the deployed system implements multiple of the plurality of output time integral neural networks in a hardware device during operation,
whereby the deployed system evolves in real time during operation.

16. The system of claim 15, wherein the deployed system comprises at least one of: a drone, a robot, an autonomous vehicle, a predicative analytics system, or an adaptive control system.

17. The system of claim 13, wherein the applying the at least one genetic operator to the fixed-point binary representations comprises applying the at least one genetic operator to at least a least significant bit of a decimal part of the fixed-point binary representations.

18. The system of claim 13, wherein the reprogramming comprises partial reprogramming using at least one of Dynamic and Partial Reconfiguration (DPR), Direct Memory Access (DMA), Diversified Factory Key (DFK), or Advanced eXtensible Interface (AXI).

19. The system of claim 13, wherein the at least one reconfigurable logic fabric comprises at least one Field Programmable Gate Array (FPGA).

20. The system of claim 13, wherein the processing system is onboard the at least one reconfigurable logic fabric.

21. The system of claim 13, wherein the processing system is on a hardware element separate from the at least one reconfigurable logic fabric.

22. The system of claim 13, wherein the at least one genetic operator comprises at least one of: mutation or crossover.

23. The system of claim 13, wherein the at least one parameter comprises one or more of: a neural network weight, a neural network bias, a time constant, a membrane conductance, a membrane resistance, a membrane decay/leak, or a relaxation.

24. The system of claim 13, wherein the fitness function comprises at least one of: an absolute difference of differentials, a minimization of target values, a maximization of target values, or a sustainment of values in satisfiable range.
